(19) United States
(12) Patent Application Publication
(10) Pub. No.: US 2012/0210069 A1
(43) Pub. Date: Aug. 16, 2012

(54) SHARED CACHE FOR A TIGHTLY-COUPLED MULTIPROCESSOR

(75) Inventors: Nimrod Bayer, Beersheba (IL); Peleg Aviely, Kadima (IL); Shareef Hakeem, Nazareth (IL); Shmuel Shem-Zion, Ashdod (IL)

(73) Assignee: PLURALITY LTD., Netanya (IL)

(21) Appl. No.: 13/503,371

(22) PCT Filed: Oct. 24, 2010
(86) PCT No.: PCT/IB10/54809

§ 371 Date: Apr. 23, 2012

Related U.S. Application Data
(60) Provisional application No. 61/254,706, filed on Oct. 25, 2009.

(51) Int. Cl. G06F 12/08

(52) U.S. Cl. 711/122; 711/E12.018; 711/E12.024

(57) ABSTRACT

Computing apparatus (11) includes a plurality of processor cores (12) and a cache (10), which is shared by and accessible simultaneously to the plurality of the processor cores. The cache includes a shared memory (16), including multiple block frames of data imported from a level-two (L2) memory (14) in response to requests by the processor cores, and a shared tag table (18), which is separate from the shared memory and includes table entries that correspond to the block frames and contain respective information regarding the data contained in the block frames.

### CROSS-REFERENCE TO RELATED APPLICATION

This application claims the benefit of U.S. Provisional Patent Application 61/254,706, filed Oct 25, 2009, which is incorporated herein by reference.

### FIELD OF THE INVENTION

The present invention relates to multiprocessor computers, also known as a multicore computers, and more particularly, to a multiprocessor computer having a shared memory system that allows many processing cores to concurrently and efficiently access random addresses within the shared memory. The present invention also relates to mechanisms for automatic caching of blocks of memory contents in a first level of a memory hierarchy.

### BACKGROUND

### Glossary of Terms

The following meanings of terms hold throughout the present disclosure, except when explicitly stated otherwise:

Data: Any kind of information that is kept as content in a memory system. (Thus, data may have any interpretation, including as instructions).

Word: An elementary granule of data that is addressable in a memory system (Thus, a word may have any width, including the width of a byte).

Block: A cluster of a fixed number of words that is transferred into a cache memory from the next level of a memory hierarchy, or in the reverse direction.

Block frame: An aligned place holder for a block within a cache memory.

### REVIEW OF RELATED ART

In a single-processor system, the memory that is directly attached to the processor typically needs to be of a limited size. This is due to considerations related to speed or to various implementation constraints. Hence, the size of this memory may be smaller than the address space required by programs that run on the system. In such a situation a memory hierarchy is commonly created, with the first level of this hierarchy, namely the memory attached directly to the processor, being configured and operated as a cache. In the prior art, the term cache is usually employed when there is provided an automatic hardware mechanism that imports blocks required by the program from the second level of the hierarchy into block frames in the first level, namely the cache. This mechanism also exports blocks of data that have been modified and need to be replaced. A description of the basic principles of the prior art regarding memory hierarchy and caches is available, e.g., in Chapter 5 entitled “Memory-Hierarchy Design” of the second edition of the book, Computer Architecture—a Quantitative Approach, by John L. Hennessy and David A. Patterson (Morgan Kaufmann Publishers Inc., San Francisco, 1996), which is incorporated herein by reference.

A common cache organization is the 2^{m}-way set-associative organization, with the parameter m assuming positive integer values. This organization is described, e.g., in the above-mentioned book by Hennessy and Patterson, starting from page 376. According to this organization, the block frames of the cache are grouped in sets of size 2^{m}. A block may be brought to just one pre-designated set of block frames, but it may be placed in any frame within that set. To check whether a given block currently sits in the cache and to locate the frame where it resides, an associative search is performed within the relevant set. This search is based on comparing the known tag of the given block against the tags of the blocks that currently occupy the block frames comprising the set; the tag of a block is determined according to the addresses of the words comprised in it, in a manner that is described, e.g., by Hennessy and Patterson, on page 378. The quantity 2^{m} can be referred to as the degree of associativity.

Another common cache organization is based on direct mapping. However, it is possible to view a directly mapped cache as a set-associative cache with sets that comprise only a single block frame (Hennessy and Patterson, page 377). The sets thus become trivial, the associativity disappears, and a block may be brought to just one pre-designated block frame. This point of view enables the following unified framework: The parameter m in 2^{m}-way set-associative is allowed to assume also the value zero, such that the phrase “1-way set-associative cache” is understood to mean a directly mapped cache. We adopt this unified framework throughout the present disclosure.

U.S. Pat. No. 5,202,987 describes a multiprocessor with a novel synchronizer/scheduler and a shared memory. A suitable sort of shared memory system for this purpose is described in PCT International Publication WO 2009/060459. (This U.S. patent and this PCT publication are both incorporated herein by reference.) This shared memory system uses a suitable interconnection network to provide multiple processing cores with the ability to refer concurrently to random addresses in a shared memory space with a degree of efficiency comparable to that achieved for a single processor accessing a private memory. Such synchronizer/scheduler and shared memory enable the processing cores to cooperate closely with each other, thus coupling the cores tightly. (The term “tightly coupled,” in the context of the present patent application, means that the processing cores share some or all of their memory and/or input/output resources.)

### SUMMARY

Embodiments of the present invention that are described hereinbelow provide a shared cache for a tightly-coupled multiprocessor.

There is therefore provided, in accordance with an embodiment of the present invention, computing apparatus, including a plurality of processor cores and a cache, which is shared by and accessible simultaneously to the plurality of the processor cores. The cache includes a shared memory, including multiple block frames of data imported from a level-two (L2) memory in response to requests by the processor cores, and a shared tag table, which is separate from the shared memory and includes table entries that correspond to the block frames and contain respective information regarding the data contained in the block frames.

In a disclosed embodiment, the shared memory is arranged as a 2^{m}-way set-associative cache, wherein m is an integer, and wherein the respective information in each table entry in the shared tag table relates to a respective set of the block frames.

In some embodiments, the apparatus includes repeat controllers respectively coupled between the processor cores and the cache, wherein each repeat controller is configured to receive requests for cache transactions from a corresponding processor core and to repeatedly submit sub-transactions to the cache with respect to the cache transactions until the requests have been fulfilled. Typically, the repeat controllers are configured to receive the requests from the processor cores to perform multiple successive transactions and to pipeline the transactions. In a disclosed embodiment, the repeat controllers are configured to access both the shared memory and the shared tag table in parallel so as to retrieve both the data in a given block frame and a corresponding table entry concurrently, and then to pass the data to the processor cores depending upon a cache hit status indicated by the table entry. Alternatively or additionally, the repeat controllers are configured to receive direct notification of importation of block frames to the cache.

In some embodiments, the cache includes an import/export controller, which is configured, in response to cache misses, to import and export the data between certain of the block frames in the shared memory and the L2 memory while the processor cores simultaneously continue to access the data in all others of the block frames in the shared memory. Typically, the information contained in the table entries of the tag table includes at least one bonded bit for indicating that the data in a corresponding block frame is undergoing an import/export process.

In a disclosed embodiment, the information contained in the table entries of the tag table includes a grace period field indicating a time interval during which a processor core can safely complete a transaction with respect to the data in a corresponding block frame.

In some embodiments, the shared tag table includes multiple memory banks, each containing a respective subset of the table entries, and multiple tag controllers, each associated with and providing access to the table entries in a respective one of the memory banks. An interconnection network is coupled between the processor cores and the tag controllers so as to permit the processor cores to submit transactions simultaneously to different ones of the tag controllers. Typically, the tag controllers are configured to detect cache misses in the associated memory banks responsively to the submitted transactions and to initiate import and export of the data in corresponding block frames of the shared memory responsively to the cache misses. In a disclosed embodiment, the apparatus includes an import/export controller, which is coupled to receive and arbitrate among multiple import and export requests submitted simultaneously by the tag controllers, and to serve the requests by importing and exporting the data between the corresponding block frames in the shared memory and the L2 memory. The interconnection network may be configured to detect two or more simultaneous transactions from different processor cores contending for a common address in one of the memory banks, and to respond by multicasting the transaction to the different processor cores, wherein if at least one of the transactions is a write transaction, then the write transaction is chosen to propagate to a tag controller of the one of the memory banks.

There is also provided, in accordance with an embodiment of the present invention, a method for computing, including providing a cache to be shared by a plurality of processor cores so that the cache is accessible simultaneously to the plurality of the processor cores. Multiple block frames of data and imported into a shared memory in the cache from a level-two (L2) memory in response to requests by the processor cores. A shared tag table, which is separate from the shared memory, is maintained in the cache and includes table entries that correspond to the block frames and contain respective information regarding the data contained in the block frames.

### BRIEF DESCRIPTION OF THE DRAWINGS

For a better understanding of the invention with regard to the embodiments thereof, reference is now made to the accompanying drawings, in which like numerals designate corresponding elements or sections throughout.

FIG. 1 is a block diagram that schematically shows a shared cache that is embedded within a tightly-coupled multiprocessor system, along with relevant system elements that surround the shared cache, in accordance with an embodiment of the present invention;

FIG. 2 is a block diagram that schematically illustrates a shared memory, showing the interrelation between the partitioning of the shared memory comprised within a shared cache into memory banks, on the one hand, and the partitioning of this shared memory into words and into block frames on the other hand, in accordance with an embodiment of the present invention;

FIG. 3(a) is a block diagram that schematically shows a set of block frames laid out as a sequence of contiguous words within the shared memory that is comprised within a shared cache, in accordance with an embodiment of the present invention;

FIG. 3(b) is a block diagram that schematically shows a chain of contiguous sets, and a sub-collection of the block frames thereof with these frames having the same index within their respective sets, in accordance with an embodiment of the present invention;

FIG. 4 is a block diagram that schematically illustrates a memory address, showing how addresses are formed and how they are parsed into sub-fields in accordance with an embodiment of the present invention, including the parsing that is related to the partitioning of the shared memory comprised in a shared cache into banks, as well as the parsing that is related to the existence of blocks, block frames and sets;

FIG. 5 is a block diagram that schematically shows the internal structure of a shared tag table subsystem, in accordance with an embodiment of the present invention; and

FIG. 6 is a block diagram that schematically shows the format of an individual entry of a shared tag table, comprising sub-items that represent block frames in the shared memory and sub-fields of a sub-item, in accordance with an embodiment of the present invention.

### DETAILED DESCRIPTION

### Overview

This section provides a detailed and comprehensive description of apparatus and methods for constructing and managing a shared cache. These apparatus and methods embody the principles of the present invention in a manner that its inventors perceive as being most efficient. Although this description concentrates on aspects that are peculiar to a shared cache for a tightly-coupled multiprocessor, some aspects that are common to such a shared cache and to a classical cache for a single processor system may be described as well, for the sake of completeness. Certain parts of the disclosure that follows rely on the shared memory scheme in above-mentioned PCT International Publication WO 2009/060459 and describe specifically the modifications and adaptations required to that scheme for implementation of a shared cache.

A person skilled in the relevant art may appreciate that in implementing the embodiments that follow, a variety of timing and pipelining schemes may be employed. The choice of a particular timing and pipelining scheme may depend on the pipeline structure of the processing cores, as well as on other factors and considerations that are not intrinsic to the shared cache itself and are independent of the principles of the present invention. For this reason, and considering the fact that pipelining schemes in a shared memory are described extensively in PCT International Publication WO 2009/060459, the description that follows does not dwell on the aspects of timing and pipelining, although it does include some guidance on these aspects.

Due to considerations similar to those arising in the context of a single processor system, a tightly-coupled multiprocessor typically needs to be endowed with a memory hierarchy that includes a cache. One way to accomplish this goal would be to provide a private cache for each processing core separately. However, such a solution will hamper the desired tight cooperation between the processing cores via the shared memory.

This situation leads to a need to configure and operate at least a part of the shared memory itself as a shared cache, which comprises an automatic hardware mechanism for importing and exporting of blocks. The basic notion of caching of blocks is akin to what is done in single processor systems, but this shared cache is distinct in that it must be able to serve tens of access transactions or more at every clock cycle.

The starting point of our cache design is a memory shared by multiple processing cores, in its original state before being augmented with automatic caching capabilities.

One suitable type of such a shared memory is described in PCT International Publication WO 2009/060459, as noted above. We are interested in configuring and operating the given shared memory as an 2^{m}-way set-associative cache, with the parameter m assuming any nonnegative integer value. Note that, as explained in the background section herein above, by allowing the case m=0 we adopt a uniform framework that includes directly mapped cache as a special case. Note also that typical values for m are 0, 1 and 2.

To implement the shared cache, tags and control contents are added, to usher in the access to the data. Hence, a tag table (which also accommodates control contents in addition to the tags) is added to the shared memory. In a shared cache system this tag table is not interlaced with the shared memory itself, but rather forms a separate module. The reasons for this separation are elucidated hereinbelow. As a module, the tag table itself is essentially a specialized shared memory. Hence it is referred to as the shared tag table. As in the case of the shared memory module that accommodates the data, one suitable way to construct the shared tag table is based on the shared memory structure of PCT International Publication WO 2009/060459. The term “shared memory” will be reserved from now on, however, to refer to the shared memory that accommodates the data, namely the original shared memory from which we set out, and the term “shared tag table” will be reserved for the other, separate module. We thus have two modules or subsystems: the shared memory and the shared tag table, which work in conjunction with one another.

We now proceed to elucidate the reasons for not interlacing the shared tag table with the shared memory:

Both the shared memory and the shared tag table are simultaneous-access systems, and both of them comprise a space of addressable items. Yet the numbers of addressable items are not the same for these two subsystems. As far as the shared memory is concerned, the number of addressable items is the number of words accessible by the processing cores. But as far as the shared tag table is concerned, the addressable items are table entries rather than words. The number of table entries is given by the expression:

(number of words in the shared memory)/(h×2^{m})

where h stands for the number of words in a block and m is the logarithm of the number of block frames in a set (same m that appears in the phrase “2^{m}-way set-associative”); this is so because one table entry corresponds to and containing information regarding the content and status of a set of block frames. In view of the fact that both the shared memory and the shared tag table are simultaneous-access systems that employ interconnection networks, the difference in the numbers of addressable items calls for optimizing their organizations separately. Furthermore, even a single block frame, let alone a set of block frames (which is represented by a table entry), can be dispersed among several banks of the shared memory by interleaving, as further explained below. This too, rules out the possibility of interlacing the shared tag table and the shared memory together.

The simultaneous nature of the shared cache is not manifested only in the fact that both the shared memory and the shared tag table are simultaneous-access systems, but also, among other things, in the fact that these two modules normally work in mutual simultaneity.

Increasing m, i.e., increasing the degree of associativity, brings the benefit of decreasing what is known as the conflict effect (as explained, for example, by Hennessy and Patterson, page 392). The same principle applies in the shared cache disclosed herein and provides motivation to enhance the degree of associativity in this shared cache, as well. However, this shared cache is a simultaneous-access system in which more than one transaction may want to access a given table entry at any given clock cycle, and the probability for this occurrence seems to rise as the sets become larger. Therefore, it might appear as if enhancing the associativity incurs a counter effect that detracts from the gain in performance. It turns out that in fact it is not so, as discussed in greater detail below. An increase of the degree of associativity does entail a penalty of another kind, though, which is unrelated to the cache being shared: Somewhat more energy is spent in an associative search, as more circuitry is activated.

As in a single processor system, there is also here a need in the shared cache for a mechanism that imports blocks from the next level of the memory hierarchy to the cache, as well as exports block that have been modified and need or are chosen to be replaced. The decision about which block to replace among the blocks in a set can be based on the least-recently-used (LRU) algorithm or on any other suitable replacement algorithm. What triggers an import/export request is a cache miss. In the shared cache disclosed herein, the mechanism responsible for handling import/export requests also has the duty of arbitrating among multiple such requests that may emerge simultaneously. The following further manifestation of the simultaneous nature of the entire shared cache system is a feature of the disclosed embodiments of the present invention: Import/export activity can be conducted while the regular activity of accessing the cache by processing cores is ongoing.

One implication of the fact that the cache is shared among multiple processing cores, so that contention between them over block frames may occur, is the following problem, to which we refer as the overtaking problem: Consider a situation in which processing core A attempts to access a word in the shared memory after receiving an affirmation from the shared tag table, but suffers some delay in completing the access to the shared memory. During this delay the relevant block is replaced, as a result of a transaction initiated by core B. Being unaware of the replacement, core A then accesses the wrong block. One simple solution for the overtaking problem is stalling all normal activity of accessing the shared memory by processing cores whenever an import/export operation takes place. Under this solution all transactions that have started and have not yet affected the state of the system are canceled, in order to be re-initiated as soon as the import/export operation completes. This solution has the following drawback: It precludes simultaneity between the regular access activity and the import/export activity.

The present disclosure therefore describes an alternative approach for solving the overtaking problem: This approach is based on letting a processing core know, when it receives an affirmation from the shared tag table, how many clock cycles are still left at its disposal to complete the transaction; that is, the core is informed by the shared tag table of the amount of time during which it is guaranteed that the block it needs will still be in place. If the transaction does not complete within the given grace period, the processing core should restart this transaction anew, with a renewed inquiry to the shared tag table.

Note that the overtaking problem is associated only with block replacements and is not associated with writes overtaking reads. If any such problem of the latter type were to occur, then it would have existed as a problem of the original shared memory from which we set out, before it was augmented with caching capabilities. However, such a problem can be avoided in a tightly-coupled multiprocessor, for example, by using the synchronizer/scheduler described in the above-mentioned U.S. Pat. No. 5,202,987, which ensures the correct order of operations through the use of a task map.

This Overview section is concluded with two lists—a first one that identifies features and traits that are common to a shared cache and to a cache in a single processor system, and a second list that identifies features and traits that are peculiar to the shared cache.

Common features:
The 2^{m}-way set-associative organization is applicable for both types of systems.
The LRU algorithm and other common replacement algorithms are equally applicable for both types of systems.
In both types of systems the importing and exporting of blocks are triggered by cache misses, and are carried out automatically by a dedicated mechanism (although some caches incorporate the “write through” method, according to which the exporting of blocks is not triggered by misses).

Features peculiar to a shared cache:
In an efficient implementation of a shared cache, the tags and control information are not interlaced with the data contents themselves. Rather, the shared memory and the shared tag table are two distinct modules or subsystems that work in conjunction with each other.
Both the shared memory (which holds the data of interest for the processing cores) and the shared tag table are simultaneous-access systems. Moreover, these two subsystems operate concurrently with each other.
There is a need for arbitration between multiple requests for importing/exporting of blocks to/from the cache from/to the next level in the memory hierarchy.
The activity of importing/exporting of blocks can be conducted while the activity of processing cores accessing the cache continues regularly.
There arises the overtaking problem, due to the fact that memory access transactions are initiated by multiple entities in a concurrent manner.
Memory access transactions may experience various forms of contention.

Embodiments of the present invention that are described hereinbelow implement these unique features and solve the problems inherent therein. The description that follows begins with a description of the system, and then continues to the elements, subsystems and operational features thereof.

### System Description

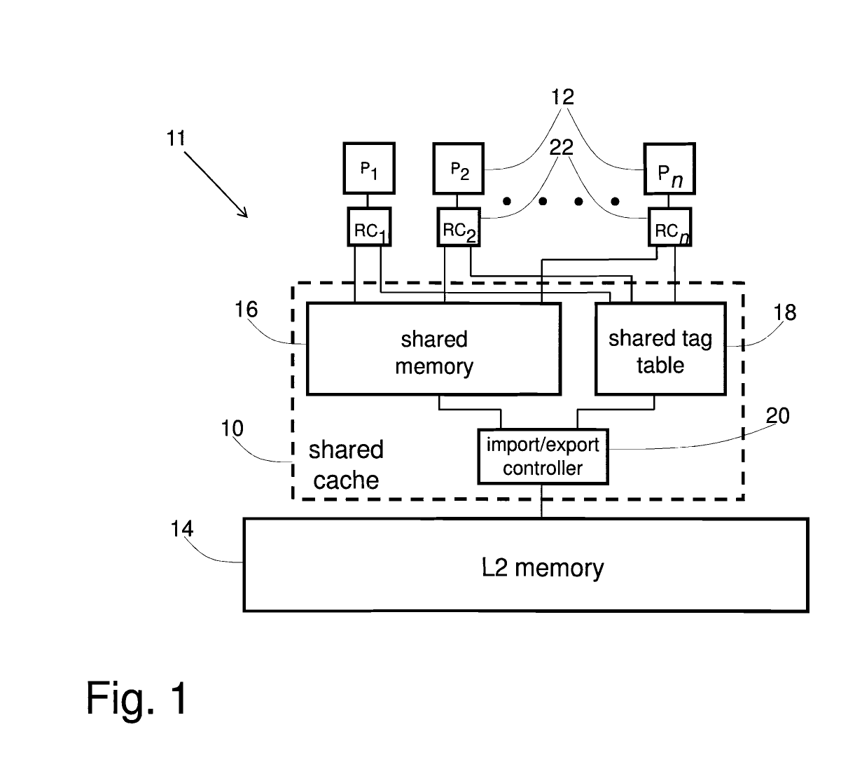

FIG. 1 is a block diagram that schematically shows a shared cache 10 that is embedded inside a tightly-coupled multiprocessor system 11, along with relevant system elements that surround this shared cache. This figure does not purport to show the entire multiprocessor system, and does not depict elements thereof that are not directly relevant to the disclosure of the shared cache. (Such elements may include, for example, a synchronizer/scheduler constructed according to U.S. Pat. No. 5,202,987.) Furthermore, the overall multiprocessor system may span multiple memory systems, and/or more than one shared cache; however, for the sake of elucidating the principles of the present invention, the description concentrates on a single shared cache.

The most prominent system elements surrounding the shared cache 10 are an array of processing cores 12 and a level-two memory (L2 memory) 14. The individual processing cores comprising the array 12 are labeled P₁, P₂, . . . Pₙ. These processing cores are the elements that initiate memory access transactions. The memory system is hierarchical, with the shared cache 10 serving as the first level of the hierarchy. For the sake of the present description, any internal means of storage that a processing core may possess, be they register files or other sorts of storage, are not considered as part of the memory hierarchy. Rather, they are considered as innards of the core. This point of view, according to which the shared cache is the first level of the memory hierarchy, has the following meaning and basis: There exists a possibility of constructing the shared cache 10 such that it is capable of supporting frequent, low-latency, fine grain (namely pertaining to small data granules) transactions, thereby enabling tight cooperation between the cores via this shared cache. From having the shared cache 10 as the first level of a memory hierarchy there follows the necessity of having a second level too; this is the L2 memory 14 shown in FIG. 1.

The shared cache 10 comprises a shared memory 16, a shared tag table 18 and an import/export controller 20. The shared memory 16 may be of the type described in PCT International Publication WO 2009/060459, augmented with automatic caching capabilities; this is the element of the shared cache 10 which holds the data to which the processing cores 12 seek access. The shared tag table 18 holds the tags belonging to the blocks that sit in the shared memory 16 together with control contents needed for ushering in the access to the shared memory 16 and for managing the entire shared cache 10; the control functions performed by the shared tag table 18 are described hereinbelow. The import/export controller 20 is responsible for importing blocks of data from the L2 memory 14 to the shared memory 16 and for exporting, in the opposite direction, of blocks that need to be written back. The imports and exports of blocks into/from the shared memory 16 are accompanied by due updates within the shared tag table 18.

FIG. 1 also features an array of repeat controllers 22. These correspond to the processing cores 12, such that every processing core Pⱼ, with j between 1 and n, has a respective repeat controller RCⱼ. A repeat controller represents a functionality that can be attributed to the core, although it could have also been attributed to the shared cache 10 itself; this is the functionality of issuing and repeating sub-transactions.

Two points of view may be adopted in describing the setup shown in FIG. 1—the resources point of view and of the transactions point of view:

From the point of view of the resources, the setup shown in FIG. 1 is fundamentally different from the classical setup of a single processor attached to a cache attached to a second-level memory. The difference is in the concurrency, which is featured all along: The array of processing cores 12 generates a stream of memory access transactions in a concurrent manner (these transactions are handled with the aid of the functionality attributed to the repeat controllers 22); the shared memory 16 and the shared tag table 18 are both simultaneous-access systems, which also operate simultaneously with each other; the import/export controller 20 is built to handle requests that arrive simultaneously. Vis-a-vis the L2 memory 14 the import/export controller 20 may also appear unlike a classical controller that handles the transfer of blocks, because these transfers may be pipelined rather than occurring one at a time.

From the point of view of a transaction, however, the setup shown in FIG. 1 appears similar in some ways to a cache attached to a single processor. Dissimilarities are associated mainly with competition with other transactions. A transaction aimed at accessing a memory location is initiated by an element of the array of processing cores 12. The respective element of the array of repeat controllers 22 then issues a sub-transaction aimed at inquiring of the shared tag table 18 whether the block containing the word with the given location in the memory space is present in the shared memory 16. This sub-transaction may fail to yield any answer, due to contention with other transactions within the shared tag table 18. In such an event the repeat controller reissues the sub-transaction, and this is repeated until a definite reply arrives. The design of the shared tag table 18 and of the overall system may be tuned so that the probability of a sub-transaction failure is below a specified limit. This sort of tuning avoids excessive traffic and substantial slowdown. The definite reply that is finally returned to the repeat controller (“finally” translates, with a high probability, into “upon the first attempt” when the design is properly tuned) is either an affirmation (signifying a cache hit) or a denial (signifying a cache miss).

Consider the affirmation (cache hit) case first. The affirmation reply is accompanied with a specification of a grace period, expressed in terms of clock cycles, during which it is guaranteed that the required block is and will stay available, and can be accessed safely in the shared memory 16. The specification of the grace period addresses the overtaking problem mentioned above. Upon receiving the affirmation, the repeat controller initiates a sub-transaction aimed at accomplishing the access of the shared memory 16 itself. If this latter sub-transaction succeeds, the overall transaction completes successfully. However, the possibility of failure exists for this new sub-transaction, and again due to contention—now within the shared memory 16. The design of the shared memory 16 may be tuned so as to ensure that the probability of such a failure is below a specified limit. In case of failure the sub-transaction is re-initiated by the repeat controller 22, provided that the given grace period has not yet elapsed. In a case where the grace period elapses before the overall transaction completes successfully, the whole transaction is repeated. Again, the design of the system may be tuned so as to ensure that the probability of such an event is below a specified limit.

Consider now the denial (cache miss) case. The attempt to access a location in the memory space that is not currently represented in the shared memory 16 usually triggers an operation of importing to the shared memory 16 of the relevant block from the L2 memory 14, and possibly also exporting to the L2 memory 14 of a block that is replaced by the newly imported one. This operation is not triggered, however, when it would interfere with another import/export operation that is already under way. Such an interference is rooted in contention between transactions, and does not occur in a classical cache of a single processor. The repeat controller 22 which receives the denial reply has to re-initiate the same sub-transaction after a waiting period that is tuned at design time or, in another embodiment of the present invention, even during operation. This re-initiation is repeated until an affirmation is finally obtained.

All the import/export operations are handled by the import/export controller 20. As multiple import/export requests may be triggered during any sequence of clock cycles (including a sequence of length-one), the function of the import/export controller 20 includes arbitration between competing requests. It also includes handling multiple import/export operations that may be underway concurrently.

A cache miss which eventually leads to an update in the constellation of blocks found in the shared memory 16, also leads to a corresponding update in the shared tag table 18. Note, however, that a cache hit, as well, may lead to an update within the shared tag table 18.

Further details of the structure and operation of the shared cache 10 are made evident hereinbelow, in the context of describing individual subsystems and elements thereof.

### The Shared Memory 16

We first consider the hardware changes that are needed when a shared memory is augmented with the capabilities needed for embedding it inside a shared cache 10. We then proceed to elucidate some interrelations between concepts related to a shared, multi-ported, memory made of banks, on the one hand, and concepts related to a cache memory on the other hand, in connection with using the shared memory in a new context, that of a shared cache 10. In this section we assume that the shared memory 16 is partitioned into memory banks. One suitable implementation of such a shared memory 16 is described in PCT International Publication WO 2009/060459.

As a hardware module, a shared memory that originally was not endowed with automatic caching capabilities remains essentially unchanged when being embedded inside a shared cache 10. There is only the following minor hardware change: One extra port is added to the existing multiple ports (these ports serve the processing cores 12). The extra port serves the import/export controller 20, and is shown in FIG. 1. Unlike the multiple ports serving the processing cores 12, which are used for reading and writing of words, the extra port that serves the import/export controller 20 is used for importing and exporting of entire blocks from/to the L2 memory 14. Hence, the properties of this added port may be different. One property that may differ is the width: In an efficient implementation it may be desirable to transfer at least one complete block in a clock cycle, which is tantamount to having the width of the port serving the import/export controller 20 equal to at least the width of a block. Also, in an efficient implementation it may be desirable to assign top priority to this port, so that it overrules all the other ports; this exempts the import/export function from any kind of contention effects.

On a related topic (which does not necessarily involve any hardware changes), when the shared memory 16 is embedded inside a shared cache 10, there arises a new confluence between two concepts: The first concept is the partitioning of the memory into banks and the related parsing of an address field into sub-fields; the second concept is the classical organization of a cache memory. The latter concept includes the partitioning of the memory space into blocks, the partitioning of the cache into block frames and into sets of block frames (in a 2^{m}-way set-associative organization), as well as, again, the related parsing of an address into sub-fields. The confluence between these two concepts calls for elucidation.

In order to provide the elucidation just mentioned we first introduce the following notation, which is used consistently throughout the rest of the present disclosure and occasionally has also been used in the preceding part; in using the notation, “logarithm,” we always means “logarithm according to base two”:

The logarithm of the degree of associativity is denoted by m. This is the same m that appears in the phrase “2^{m}-way set-associative”.

The logarithm of the number of memory banks comprised in the shared memory 16 is denoted by k.

The logarithm of the number of words contained in a single memory bank is denoted by d.

The logarithm of the number of words contained in a single block is denoted by h (typical values of h are between 2 and 6).

The logarithm of the number of words in the entire memory space is denoted by w. (The very existence of a memory hierarchy suggests that 2^{w} significantly exceeds the capacity of the shared memory 16, which is expressed by 2^{k+d}).

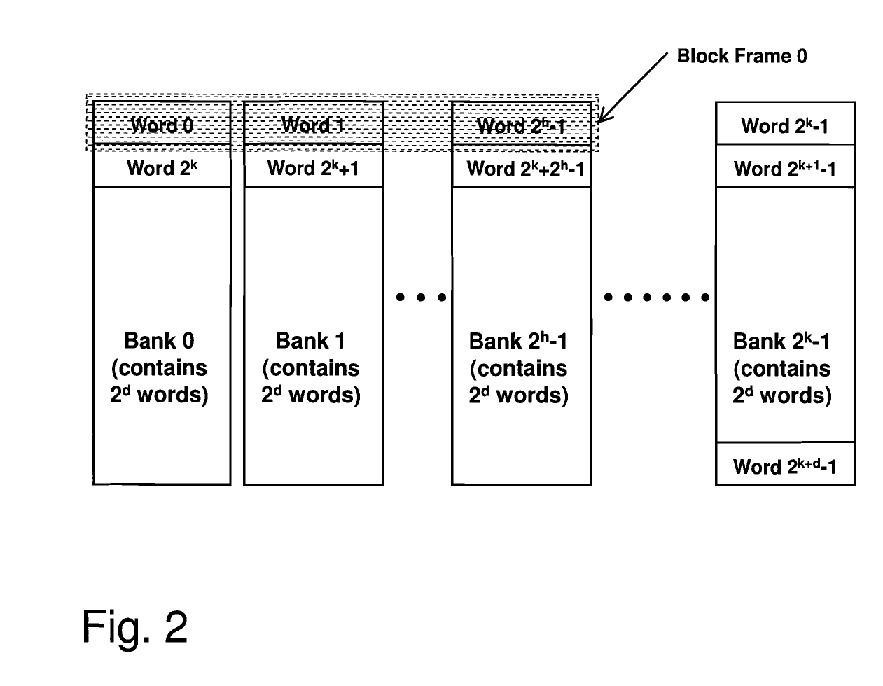

Having introduced the above notation, we now provide the elucidation using FIGS. 2, 3 and 4:

FIG. 2 illustrates the interrelation between the partitioning of the shared memory 16 into memory banks, on the one hand, and its partitioning into words and into block frames on the other hand. This figure uses numbers and numeric expressions (such as “0”, “1” or “2^{k}+1”) as indices of array elements. The usual use of numerals in figures is therefore avoided in this figure, to prevent confusion. The shared memory 16 constitutes an array of 2^{k} memory banks, indexed from 0 to 2^{k}−1. As each memory bank contains 2^{d} words, the overall number of words in the shared memory 16 is 2^{k+d}. These 2^{k+d} words constitute an array which is indexed from 0 to 2^{k+d}−1. The words are arranged in such a way that Word 0 is located in Bank 0, Word 1 is located in Bank 1, and so forth; this is due to the principle of interleaving, as discussed in PCT International Publication WO 2009/060459. The shared memory 16 is also partitioned into 2^{k+d-h} block frames, with each block frame encompassing 2^{h} words. The array of block frames is indexed from 0 to 2^{k+d-h}−1. Among these, FIG. 2 shows only Block Frame 0, which comprises Word 0 to Word 2^{h}−1. The fact that a block frame consists of a sequence of contiguous words is due to the principle of spatial locality (as explained on page 38 of Hennessy and Patterson, for example). Thus, the combination of the two principles—that of interleaving (which applies to a shared memory made of memory banks) and that of spatial locality (which applies to a cache memory), implies that the words of a block frame are dispersed among different memory banks. This is one reason for the fact that the shared memory 16 and the shared tag table 18 are separated rather than interlaced, as discussed above.

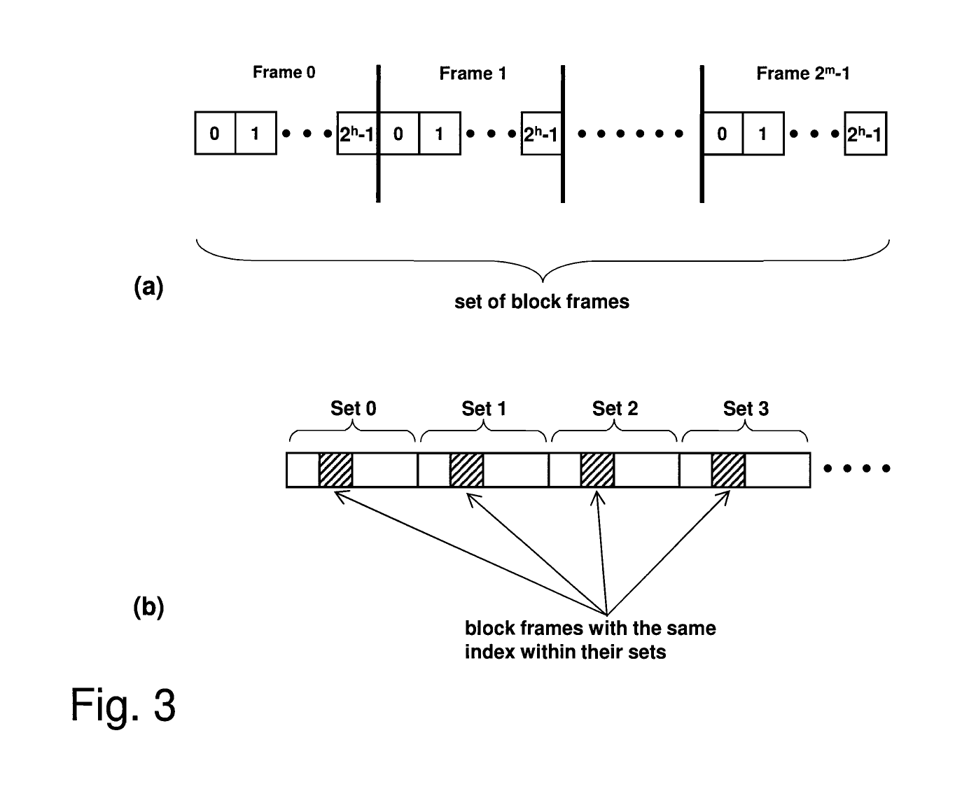

FIG. 3 likewise uses numbers and expressions as indices of array elements and avoids the usual use numerals in figures. FIG. 3(a) shows how a set of 2^{m} block frames is laid out within the shared memory 16 as a sequence of contiguous 2^{h+m} words: The sequence is composed of 2^{m} block frames that are indexed from 0 to 2^{m}−1, while the indexing of the words within a block frame internally is from 0 to 2^{h}−1. A set plays a role in the 2m-way set-associative organization, and is meaningful to the functioning of the shared tag table 18 as discussed in a later section hereinbelow. FIG. 3(b) shows a chain of contiguous sets, and a sub-collection of the block frames thereof, with one block frame chosen from each set; all those chosen in this example have the same index within their respective sets.

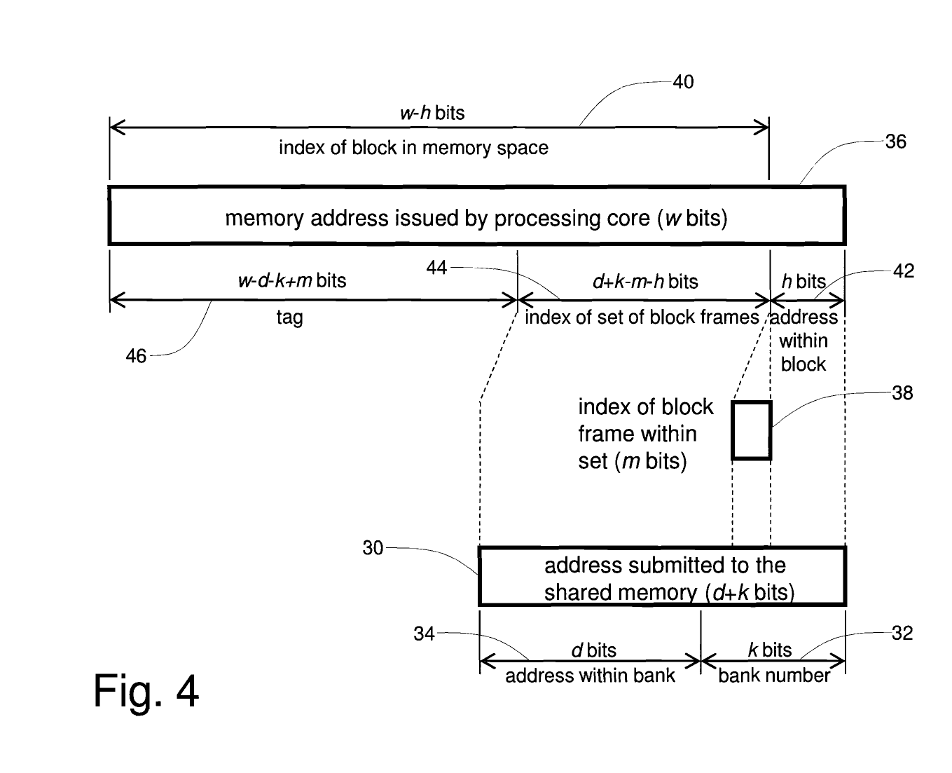

FIG. 4 shows how addresses are formed and how they are parsed into sub-fields, in compliance with the layouts shown in FIGS. 2 and 3. The following convention is adopted in this figure: Bits that appear at the left side have greater significance than those that appear at the right side. Consider first the parsing into sub-fields that is related to the partitioning of the shared memory 16 into banks: An address 30 that is submitted to the shared memory 16 by one of the repeat controllers 22 comprises k+d bits. The k rightmost bits of the address 30 select the bank that is being accessed; they form the bank number 32. The remaining d bits select the word within the selected memory bank; this is the address-within-bank field 34.

Consider now the parsing into sub-fields that are related to the existence of blocks, block frames and sets: A memory address 36 that is issued by a processing core 12 comprises w bits. Also, an index of a frame within set 38 that is extracted from the shared tag table 18 comprises m bits (to recall the meaning of this index refer to FIG. 3(b)). The w-h leftmost bits of the address 36 indicate the block which contains the word sought after; this is the index of the block in memory space 40. The remaining h bits indicate the location of this word within the indicated block; this is the address-within-block field 42. The fields of the address 36 that take part in forming the address 30 include field 42, as well as the neighboring field 44, which comprises d+k−m−h bits. Field 44 signifies the index of a set of block frames—it indicates the only set where the block containing the word sought after may reside in the shared memory 16 when this shared memory is operated as part of a 2^{m}-way set-associative shared cache 10.

These two fields 42 and 44 of the address 36 are combined with the index 38 to form the address 30, as shown in this figure. The w−d−k+m leftmost bits of the address 36 that do not take part in forming the address 30 constitute the tag field 46. The tag 46 is submitted by a repeat controller 22 to the shared tag table 18 in order to check whether it matches any of the tags held within the table entry that represents the set whose index is specified in field 44.

### The Shared Tag Table 18

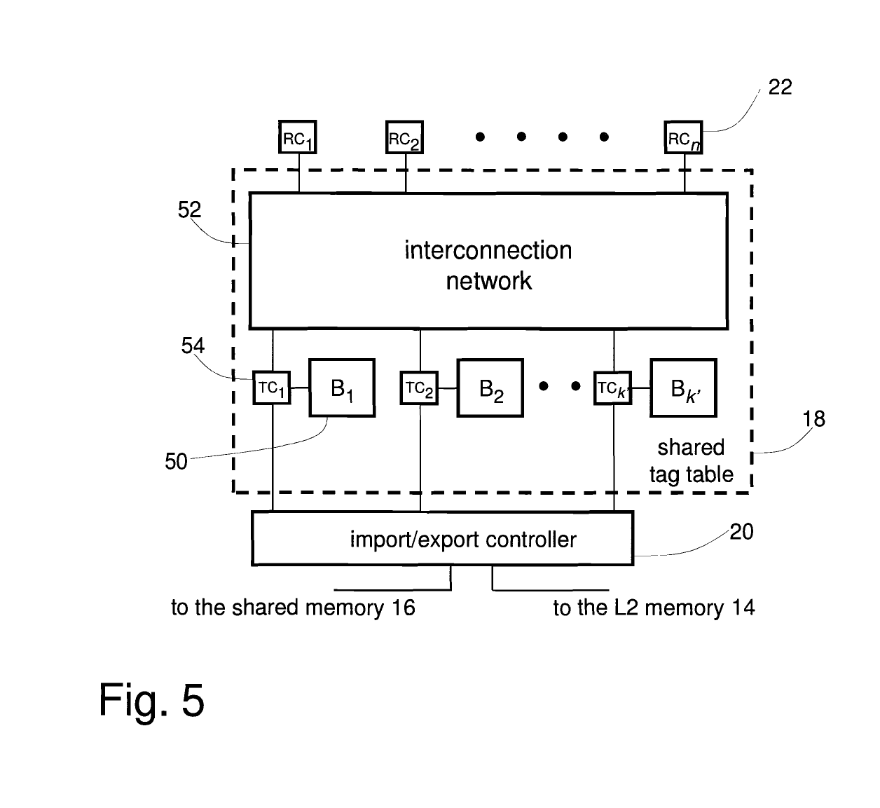

FIG. 5 is a block diagram that schematically shows the internal structure of the shared tag table 18, in accordance with an embodiment of the present invention. The shared tag table subsystem 18 includes the following elements:
1. Table entry banks 50, which are labeled B₁, B₂, . . . B_{k′}, each containing a subset of the table entries.
2. An interconnection network 52.
3. Tag controllers 54, which are labeled TC₁, TC₂, TC_{k′}. They correspond to the table entry banks 50, such that every table entry bank Bⱼ, with j between 1 and k′, has a respective tag controller TCⱼ. The tag controllers 54 represent all the control, decision, access guarding and per-module computation functionalities associated with the table entry banks 50. By incorporating all this functionality inside the tag controllers 54, the present description thus leaves the table entry banks 50 themselves only with the functionalities of passive storing of contents and of per-entry computation.

In the figure there are also shown some system elements that surround the shared tag table 18 (compare with FIG. 1). These are the repeat controllers 22 (whose role includes the issuing of sub-transactions to the shared tag table 18, as described hereinabove), the import/export controller 20, the path between the import/export controller 20 and the L2 memory 14, and the path between the import/export controller 20 and the shared memory 16.

Each of the elements 50, 52 and 54 of a shared tag table 18, which appear for the first time in the above description of FIG. 5, is elaborated upon hereinbelow.

### 1. The Table Entry Banks 50

From the point of view of the macroscopic structure of the shared tag table 18, as shown in FIG. 5, the role played by the table entry banks 50 is analogous to the role played by the memory banks within the shared memory 16. Hence, the description in PCT International Publication WO 2009/060459 is generally applicable to the design of the collection of entry banks 50. (This includes the interleaving of successive addressable items across the banks, among other aspects). The format and contents of the addressable items contained in the entry banks 50, however, differs from that described in PCT International Publication WO 2009/060459, as will be explained immediately below. This explanation is followed by a brief discussion of a performance issue, related to the contention in accessing sub-items of an addressable item.

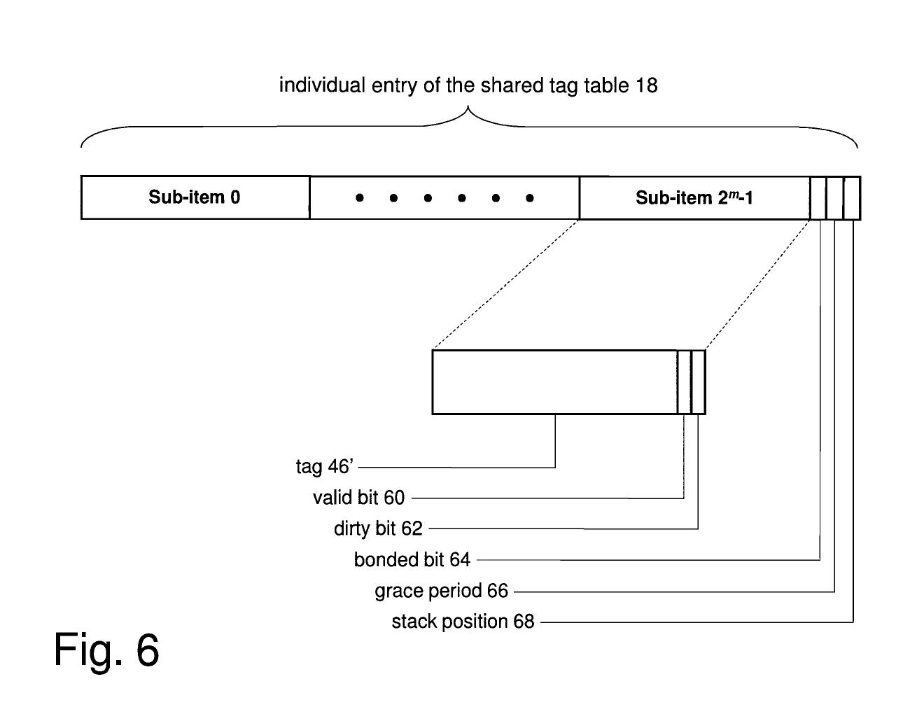

Unlike the addressable items of the memory banks of the shared memory 16, which are words, an addressable item of a table entry bank 50, namely an individual table entry, is a composite set of information that represents the state of a set of 2^{m} block frames. To fulfill this purpose, an addressable item comprises tags and various control values, as shown in FIG. 6.

FIG. 6 shows the format of an individual entry of the shared tag table 18. Such a table entry is an elementary addressable item of a table entry bank 50. The addressable item consists of 2^{m} sub-items, which represent the same number of block frames in the shared memory 16. All of these 2^{m} block frames belong to the same set (compare with FIG. 3 (a)). The sub-fields comprised in one sub-item are shown in the lower part of FIG. 6. The ratios of the widths of the sub-fields in the figure are meant to be suggestive of the number of bits that these sub-fields span. Here is a description of these sub-fields, some of which (but not all) are found also in caches for single-processor systems:

The valid bit 60 indicates whether the relevant block frame in the shared memory 16 currently contains a block, or whether it is empty.

The other sub-fields have no meaningful contents when the valid bit 60 is off. The description of the meanings of these other sub-fields relates to the case in which the valid bit 60 is in an on state.

The tag 46′ is an identification of the block that currently sits in the relevant block frame. It was obtained from the tag field 46 (see FIG. 4) of a memory address, and serves in comparisons made with the tag field 46 of memory addresses issued later.

The dirty bit 62 indicates whether the block sitting in the relevant block frame has been modified during its sojourn in the cache so far; when this bit is on, it means that the block must be written back (exported) before another block is imported to the same frame.

The bonded bit 64 is needed in a system such as presented herein, of a shared cache that serves contending transactions issued by multiple processing cores. The bonded bit turns on, and the relevant block frame thus becomes bonded, when an import/export process pertaining to the relevant block frame is triggered. The triggering and commencement of another import/export process, ensuing from a contending transaction, is prevented as long as the current process is under way; this is a state that is indicated by the bonded bit being in an on state. Moreover, the bonded bit may turn off after an additional delay rather than immediately as the import/export process terminates, with this delay being determined and tuned by the system designer: Such an extra delay is meant to avoid thrashing.

The grace period 66 is a forward-looking time interval, measured in quanta of clock cycles and starting from the current cycle, during which it is guaranteed to be safe to complete a memory access transaction that targets the relevant block frame. Normally, the grace period value is a constant that depends on the inherent delays of the overall system and expresses the minimal number of clock cycles that must elapse from the moment that an import/export is triggered and until the contents of the relevant block frame actually begin to be modified. If this number of cycles is too short to allow most memory access transactions to complete safely, then the system designer can prolong the delay artificially. When the bonded bit 64 turns on, it starts an automatic countdown of the grace period 66. This countdown stops when reaching zero. The grace period 66 is reset to its normal value when the bonded bit 64 turns off. The grace period 66 is generally measured in quanta of clock cycles rather than in discrete clock cycles in order to narrow the width (measured in bits) of the grace period field. The size of these quanta can be chosen by the implementer. (A size of one, which means that the quanta are actually discrete cycles, is as legitimate as any other size that is a whole power of two).

Finally, the stack position 68 serves the replacement algorithm. Any replacement algorithm known in the art of 2^{m}-way set-associative non-shared caches is also applicable to the present shared cache. For example, we may assume that the chosen replacement algorithm is Least Recently Used (LRU). This algorithm is based on the notion that the block frames belonging to a set form a stack, as far as the process of selecting the block to be replaced is concerned. The contents of the stack position sub-field 68 express the current position of the relevant frame in the stack. As there are 2^{m} frames in a set, the width of this sub-field is m bits. A possible simple improvement, relevant for the case in which the shared cache is two-way set-associative, namely m=1, is expressing the state of the stack using a single bit, instead of including one stack position bit for each of the two sub-items of a table entry.

(This concludes the listing of the sub-fields of a sub-item of an individual entry of the shared tag table.)

The entities that access and manipulate the tag table entries (namely, they access and manipulate the addressable items of the table entry banks 50) are the tag controllers 54. Therefore, the roles and usages of the various subfields of a sub-item of an individual addressable item of a table entry bank 50 are further clarified in connection with the description of the tag controllers 54 hereinbelow (which follows a discussion of the interconnection network 52).

We conclude this description of the table entry banks 50 with a brief discussion of a performance issue, related to contention in accessing sub-items of an addressable item of an entry bank 50. The number of such sub-items is equal to the degree of associativity, namely 2^{m}. The rationale for raising the degree of associativity is diminishing the penalty associated with the conflicts between blocks: see for example Hennessy and Patterson, page 390. However, unlike a cache of a single processor system, the shared cache disclosed herein is a multiple-access system in which many transactions compete for the tag table entries. Therefore, the following question duly arises: Doesn't raising the number of sub-items within a single addressable item of an entry bank 50 cause more contention over that addressable item? Isn't a new conflict effect thus created, now between transactions rather than between blocks, which counterbalances the gain obtained by reducing the block conflict effect? It turns out that the answer is negative, as we now explain:

The maximal number of transactions that the shared tag table 18 can admit simultaneously is the number of table entry banks 50. The selection of this number is unrelated to the degree of associativity. However, the scattering of the incoming transactions among the banks may affect the system throughput: When many transactions tend to contend for the same bank, the throughput is reduced. The contention for the same bank, which results from the need to access different sub-items of the same individual table entry (the sub-items representing different frames that belong to the same set), however, is no more intense than the contention over a collection of the same number of sub-items that are randomly picked among any table entries. Indeed, this can be seen by observing FIG. 4: When two different memory addresses 36 issued by processing cores share the same index of a set of block frame 44, then they may either also share the tag 46 or differ in the tag 46. In the former case the transactions want to refer to the very same frame and hence to the very same sub-item, so that this is not a competition over different sub-items of the same individual table entry. On the other hand, In the latter case where the tag fields 46 are different, it means that the addresses issued by the cores are far apart, because the tag field occupies the more significant bits of an address. This means that the probability that such addresses are issued together during the same narrow time interval is not higher than the probability that any addresses picked randomly are issued together during such a time interval: An a-priori higher probability for being issued together exists only for addresses that are not distant from each other, by the principle of spatial locality mentioned hereinabove.

### 2. The Interconnection Network 52

The interconnection network described herein is based on the disclosure in PCT International Publication WO 2009/060459. Here we use the latter publication as a basis, and specify only the differences/adaptations relatively to this basis. PCT International Publication WO 2009/060459 describes an interconnection network that comprises one sub-network serving only for reading and another sub-network serving only for writing. We use one of these sub-networks as a basis for the present description of the interconnection network 52 comprised within the shared tag table subsystem 18 because, like each of these two sub-networks, the network 52 described here supports a single type of transactions. As there is a greater similarity to the read sub-network, particularly due to the support of multicasts, we choose to use the read sub-network as the basis for the description; however, some resemblances between the interconnection network 52 and the write sub-network mentioned in PCT International Publication WO 2009/060459 exist as well.

The interconnection network 52 computes and allocates paths from the repeat controllers 22 associated with the processing cores 12 to the tag controllers 54 associated with the table entry banks 50. Such a path must be created once for each tag table application sub-transaction of a memory access transaction; a memory access transaction may include more than one tag table application sub-transaction in the case of a cache miss.

One difference between the interconnection network 52 and the read sub-network described in PCT International Publication WO 2009/060459 is as follows: Unlike the read sub-network, here there are carried, together with the address and other related signals, some further contents along a path in the direction from the initiator of the sub-transaction (namely a repeat controller 22 associated with a processing core 12) to the other end (namely a tag controller 54 associated with a table entry bank 50). These further contents comprise a
a) read/write bit, and a
b) block tag.

While in the context of the entire memory access transaction, the read/write bit plays the role of determining the type of transaction, in the limited context of the tag table application sub-transaction there is only one type of transaction; hence the read/write bit does not play any such role here. Rather, the read/write bit is used for updating the dirty bit 62 of a sub-item of an individual entry of the shared tag table 18 (see FIG. 6). The block tag, which is carried on the path along with the read/write bit, is drawn from the tag sub-field 46 of the memory address involved in the transaction (see FIG. 4) and is used for making comparisons against the tags 46′ contained within an individual entry of the shared tag table 18 (see FIG. 6). In the case of a cache miss, the block tag value carried along a path within the interconnection network 52 is eventually written in one of the tag 46′ sub-fields (see FIG. 6). Thus, the read/write bit and the block tag constitute contents which are carried through the interconnection network 52 and may be written at the other end.

Another difference between the interconnection network 52 and the read sub-network described in PCT International Publication WO 2009/060459 is related to the manner in which multicasting works: In the read sub-network It is both necessary and sufficient for several simultaneous transactions contending for common network building blocks to try to reach the same address in the same bank in order to allow a multicast to happen. In the interconnection network 52 described herein this is also a necessary condition—note that here “a bank” is a table entry bank 50 and an address in the bank belongs to an individual entry of the shared tag table that comprises 2^{m} sub-items (see FIG. 6). This necessary condition is not sufficient here, however: If two transactions (in the context of the entire shared cache system 10 these are sub-transactions) do not involve the same block tags, then the two corresponding replies cannot come from the same sub-item of the common tag table entry; the two replies thus have the potential to be different and therefore cannot be multicast.

This issue is addressed as follows: In PCT International Publication WO 2009/060459, multicasting is based on performing comparisons at the network's building blocks. In the present embodiment, the addresses sent along the interconnection network 52 are augmented with block tag values, and the comparisons are performed using the block tag as a part of the address. The read/write bits play no role in the multicast decisions. Nevertheless, the multicast decision affects the read/write output of the network's building block. A successful comparison requires the update of the unified transaction toward the next network building block. If one of the two transactions is a write transaction, the output transaction is selected to be a write one.

The information items that are passed through the interface between a port of the interconnection network 52 and a repeat controller 22 include an address and contents that have been read, along with a read/write bit and a block tag. The address signifies the index of a set of block frames in the shared memory 16 (see FIG. 3), and is obtained from the sub-field 44 of a memory address issued by a processing core (see FIG. 4). The contents that have been read include a hit/miss bit and a grace period value: The hit/miss bit tells the repeat controller 22 whether the sub-transaction is successful and the desired block currently sits in the shared memory 16 and can be accessed; while the grace period value, which has been obtained from a sub-field 66 of a sub-item of an individual entry of the shared tag table that has been accessed (see FIG. 6), defines a time limitation for a possible access. Apart from these information items there are control bits that indicate whether actual information is being sent or in fact the lines are idle in the current clock cycle.

Consider now the interface at the other end of the interconnection network 52 between a port of the network and a tag controller 54. The information items that are passed through such an interface are almost the same as those just described with regard to the interface with a repeat controller 22. The only difference is that the address that arrives at the interface with a tag controller 54 has a part of it stripped off: That part has been used for computing the path within the interconnection network 52 to the appropriate table entry bank 50, as described in PCT International Publication WO 2009/060459; the remaining part of the original address defines an internal address within the table entry bank 50.

The shared memory 16 (see FIG. 1) may also contain an interconnection network built according to the principles described in PCT International Publication WO 2009/060459. However, the values chosen for various parameters and design options for these two networks, namely the interconnection network 52 of the shared tag table and the interconnection network contained in the shared memory 16, are independent of one another. The separation and non-interlacement between the two interconnection networks enables each of them to suit its own role optimally.

### 3. The Tag Controllers 54

The present embodiment may be viewed in such a way that the passive role of merely holding table entries is identified with a table entry bank, as described above, whereas the active role of making comparisons between table entry fields and information coming from the interconnection network, updating table entries and negotiating with the import/export controller via a “funnel” of internal connections is identified with a separate unit—a tag controller. In fact, every table entry bank is associated with its own tag controller, as shown in FIG. 2, so these two units can alternatively be viewed as a single integrated entity. In one embodiment in which a table entry bank is single-ported, the associated tag controller can access a single table entry at each clock cycle, with such an access involving a read and possibly also a write.

When focusing on a single isolated tag controller (temporarily ignoring the fact that there are two multi-access subsystems, namely the shared memory and the shared tag table), the operation of such a tag controller is comparable to the management of a 2^{m}-way associative cache in a single processor system. The main difference is that because this is a shared cache, a tag controller may experience contention with other tag controllers when attempting to initiate an import/export operation. Another phenomenon that characterizes a shared cache is that between a request directed at the import/export controller to replace a block and the actual replacement, the tag controller may encounter further misses that entail more requests.

We now describe the operation of a tag controller in detail. The description below refers to one embodiment in order to explain and demonstrate one particular implementation; alternative implementations will be apparent to those skilled in the art after reading the present description and are considered to be within the scope of the present invention.

We begin with listing the data items that the tag controller operates upon during any given clock cycle; these data items serve as inputs, outputs, or both. Firstly, data items that belong to the interface between the tag controller and the interconnection network:

| | | serves as input | |
|---|---|---|---|
| | | or as output? | |
| | | (from the point | |
| name of the | type or range of | of view of the | |
| data item | possible values | tag controller) | meaning/role |
| query_tag | the range of | input | tag of a block which is sought |
| | values of block | | in the cache |
| | tags in the system | | |
| | (see Hennessy | | |
| | and Patterson) | | |
| query_entry | the range of | input | address of an entry within the |
| | addresses of | | associated table entry bank; |
| | entries within a | | this entry represent a block |
| | table entry bank | | frame in the shared memory or |
| | | | a set of block frames where a |
| | | | block sought after may be |
| | | | found |
| query_read/write | boolean | input | indicates whether the block is |
| | | | sought in the shared memory |
| | | | in order to read a data word |
| | | | from it or to write a word. |
| query_valid | boolean | input | indicates whether a valid |
| | | | query that arrives through the |
| | | | interconnection network is |
| | | | directed at the tag controller at |
| | | | the current clock cycle |
| query_accepted | boolean | output | indicates whether the tag |
| | | | controller can handle the |
| | | | query |
| response_{—} | boolean | output | indicates whether there is a |
| hit/miss | | | match between the tag |
| | | | submitted and the tag(s) |
| | | | stored within the entry being |
| | | | accessed |
| response_which_{—} | between 0 and | output | indicates the identity of a block |
| frame | m − 1 | | frame within a set |
| response_grace_{—} | range of | output | indicates the grace period of |
| period | grace_period field | | the repeat controller for shared |
| | | | memory access duration |
| | | | before new access is required |
| | | | to the shared tag table |

Secondly, data items that belong to the interface between the tag controller and the “funnel,” or in other words the interface between the tag controller and the import/export controller via the funnel:

| | | serves as input | |
|---|---|---|---|
| | | or as output? | |
| | | (from the point | |
| name of the | type or range of | of view of the | |
| data item | possible values | tag controller) | meaning/role |
| request_entry | the range of | output | address of an entry within the |
| | addresses of | | associated table entry bank; |
| | entries within a | | this entry represent a block |
| | table entry bank | | frame in the shared memory or |
| | | | a set of block frames into |
| | | | which a block should be |
| | | | imported. |
| request_tag_{—} | the range of | output | tag of a block that should be |
| exported | values of block | | exported to the next level of |
| | tags in the system | | the memory hierarchy. |
| request_tag_{—} | the range of | output | tag of a block that should be |
| imported | values of block | | imported from the next level of |
| | tags in the system | | the memory hierarchy. |
| request_export_{—} | boolean | output | indicates whether both export |
| needed | | | and import are needed or only |
| | | | import is needed. |
| request_valid | boolean | output | indicates whether a valid |
| | | | request for an import/export |
| | | | operation is placed by the tag |
| | | | controller at the current clock |
| | | | cycle. |
| request_{—} | boolean | input | indicates whether the |
| accepted | | | import/export controller can |
| | | | respond to a request from this |
| | | | tag controller at the current |
| | | | clock cycle. |
| update_entry | the range of | input | address of an entry within the |
| | addresses of | | associated table entry bank; |
| | entries within a | | this entry represent a block |
| | table entry bank | | frame in the shared memory or |
| | | | a set of block frames which is |
| | | | being updated by the |
| | | | import/export controller. |
| update_tag | the range of | input | the tag of a block that was |
| | values of block | | imported to the shared |
| | tags in the system | | memory. |
| update_valid | boolean | input | indicates whether the |
| | | | import/export controller (via |
| | | | the funnel) wants to make an |
| | | | update within the table entry |
| | | | bank associated with this tag |
| | | | controller at the current clock |
| | | | cycle. |

Thirdly, the table below lists data items that reside in the associated table entry bank. In this embodiment, the tag controller can access or operate upon one and only one tag table entry within the associated table entry bank at any given clock cycle, with this entry being randomly chosen. Furthermore, the tag controller is not capable of handling new transactions from the interconnect network while waiting for response to a cache miss request. Hence, what we describe in the following table are the data items comprised in a single tag table entry. Here the parameter m stands for the number of block frames in a set, assuming that the cache is organized as set-associative; however when m=1 it means that the cache is directly mapped rather than set-associative.

| | | serves as input | |
|---|---|---|---|
| | | or as output? | |
| | | (from the point | |
| name of the | type or range of | of view of the | |
| data item | possible values | tag controller) | meaning/role |
| tab_tag₁ to | the range of | both input | These are the tags of the |
| tab_tagₘ | values of block | and output | blocks that currently sit in the |
| | tags in the system | | shared memory, at the block |
| | | | frames that belong to the set |
| | | | which is represented by this |
| | | | entry of the tag table. |
| tab_valid₁ to | boolean | both input | These boolean variables relate |
| tab_validₘ | | and output | to block frames of the shared |
| | | | memory in a similar manner as |
| | | | the variables tab_tag₁ to |
| | | | tab_tagₘ. The variable |
| | | | tab_validⱼ, with j being any |
| | | | number between 1 and m, |
| | | | indicates whether the |
| | | | corresponding frame has been |
| | | | initialized with any block |
| | | | brought from the next level of |
| | | | the memory hierarchy, or is |
| | | | the frame uninitialized. |
| tab_dirty₁ to | boolean | both input | These boolean variables relate |
| tab_dirtyₘ | | and output | to block frames of the shared |
| | | | memory in a similar manner as |
| | | | the variables tab_tag₁ to |
| | | | tab_tagₘ. The variable |
| | | | tab_dirtyⱼ, with j being any |
| | | | number between 1 and m, |
| | | | indicates whether the |
| | | | corresponding frame contains |
| | | | a block that has been modified |
| | | | and thus needs to be exported |
| | | | to the next level of the memory |
| | | | hierarchy before a new block |
| | | | is imported to this frame. |
| tab_bonded | boolean | both input | This boolean variable indicate |
| | | and output | whether the corresponding set |
| | | | represented by this entry is in |
| | | | an import/export process. |
| tab_grace_period | range of the grace | both input | This variable is set for |
| | period duration | and output | maximum value after |
| | | | initialization stage. When a |
| | | | cache miss happen and |
| | | | tab_bonded is set to true, it |
| | | | counts down to zero. During |
| | | | this period, new cache miss |
| | | | requests are guaranteed to |
| | | | have a stable shared data |
| | | | access during a period defined |
| | | | by the counter value. If |
| | | | tab_bonded field is true and |
| | | | tab_grace_period is zero, the |
| | | | response for new cache |
| | | | access to the entry will return |
| | | | query_accepted = false. |
| access_record | the type depends | both input | This data item records in some |
| (use the stack | on the number m | and output | way the accessing of block |
| position field as | and on the | | frames that belong to the set |
| shown in FIG. 6, | replacement | | represented by this table |
| item 68) | algorithm | | entry, for the sake of choosing |
| (Note description | employed. When | | which block to replace next. |
| of the function | m = 1 this data | | Any suitable replacement |
| r(access_record) | item is absent. | | algorithm may be used, such |
| in the right | When m = 2 and | | as the LRU algorithm. When m = |
| column.) | the replacement | | 2, a single bit is sufficient to |
| | algorithm is LRU, | | represent the state of the |
| | this is a single bit. | | stack. |
| | | | The index of a frame within the |
| | | | set whose block should be |
| | | | replaced next is a function of |
| | | | access_record. This index is a |
| | | | number between 1 and m. We |
| | | | denote this function as |
| | | | r(access_record). We extend |
| | | | this function such that it is |
| | | | defined also when at least one |
| | | | of the data items tab_valid₁ to |
| | | | tab_validₘ is false. In such a |
| | | | case, the value of |
| | | | r(access_record) is some j |
| | | | such that tab_validⱼ is false. |

Having listed the data items that the tag controller operates upon during any given clock cycle, we now describe the possible operations taken by the tag controller, as listed in the table below, which is followed by a verbal explanation of the operations.

| operation | | |
|---|---|---|
| type | conditions | action of the tag controller |
| idle | query_valid = false; | query_accepted = false; |
| | update_valid = false; | request_valid = false |
| | in the last cycle with | |
| | request_valid = true there was | |
| | also request_accepted = true | |
| cache hit | query_valid = true; | query_accepted = true; |
| | update_valid = false; | response_hit/miss = hit; |
| | there is a number j between 1 and | response_which_frame = j; |
| | m such that tab_tagⱼ[query_entry] = | response_grace_period = |
| | query_tag and tab_validⱼ | tab_grace_period[query_entry]; |
| | [query_entry] = true; | request_valid = false; |
| | in the last cycle with | tab_dirtyⱼ[query_entry] = |
| | request_valid = true there was | query_read/write; |
| | also request_accepted = true | update access_record[query |
| | tab_bonded[query_entry] = false | entry] to record the fact that j was |
| | or (tab_bonded[query_entry] = true | accessed last; |
| | and tab_grace_period[query_entry] > 0) | |
| cache | query_valid = true; | query_accepted = true; |
| retry | update_valid = false; | response_grace_period = 0; |
| | there is a number j between 1 and | request_valid = false; |
| | m such that tab_tagⱼ[query_entry] = | |
| | query_tag and tab_validⱼ | |
| | [query_entry] = true; | |
| | in the last cycle with | |
| | request_valid = true there was | |
| | also request_accepted = true | |
| | tab_bonded[query_entry] = true and | |
| | tab_grace_period[query_entry] = 0); | |
| cache | query_valid = true; | query_accepted = true; |
| miss | update_valid = false; | response_hit/miss = miss; |
| | there is no number j between 1 and | request_valid = true; |
| | m such that tab_tagⱼ[query_entry] = | request_entry = query_entry; |
| | query_tag and tab_validⱼ | request_tag_imported = |
| | [query_entry] = true; | query_tag; |
| | in the last cycle (before the current | tab_bonded[query_entry] = true; |
| | cycle) with | tab_grace_period[query_entry] = |
| | request_valid = true there was | maximum value; |
| | also request_accepted = true | |
| import/ | update_valid = false; | query_accepted = false; |
| export | in the last cycle with | request_valid = true; |
| retry | request_valid = true there was | (request_entry, |
| | also request_accepted = false | request_tag_imported) keeping |
| | | their values from the last cycle |
| | | with request_valid = true; |
| | | tab_grace_period[request_entry] = |
| | | maximum value; |
| table | update_valid = true | query_accepted = false; |
| update | | request_valid = false; |
| | | j = r(update_entry); |
| | | request_frame = j; |
| | | request_tag_exported = tab_tagⱼ |
| | | request_export_needed = |
| | | tab_dirtyⱼ |
| | | tab_tagⱼ[update_entry] = |
| | | update_tag; |
| | | tab_validⱼ [update_entry] = true; |
| | | tab_dirtyⱼ [update_entry] = false; |
| | | tab_bonded[update_entry] = false; |
| | | tab_grace_period[update_entry] = |
| | | maximum_value; |

### Operational Description

Idle: This state occurs when there is no new transaction from the interconnection network or the import/export controller to the tag controller. All the entries in the tag table entry bank are static, except for the grace_period field counting down if the bonded bit is set to true.

Cache hit: A new query from the interconnect network arrives at the tag controller. The following conditions should be met for the tag controller to respond in this way:
a. The tag controller is not busy in “import/export retry” or “table update” state.
b. One of the tag fields accessed using the query tag address is valid and matches the query tag field
c. There is no cache miss in progress, or the grace period is not over when a cache miss is in progress for the entry

The responses provided by the tag controller include the tag identity (which way) and the grace period value.

Cache retry: The reason for this response, when the tag controller is not busy with an “import/export retry” or “table update,” is the expiration of the grace period while an ongoing cache miss is expected to initiate a table update transaction in the next few cycles. A hit indication with a zero grace period value informs the repeat controller that it will need to retry the access within few cycles. The cache retry response can separate a negative response to the repeat controller due to unsuccessful access through the interconnection network from a successful crossing of the interconnection network to an entry for which the grace period has already elapsed. The latter requires a different delay before access retry compared to an unsuccessful interconnection network crossing.

Cache miss: This response can result when a new query is received from the interconnection network to the tag controller. The following conditions should be met for the tag controller to respond this way:
a. The tag controller is not busy in “import/export retry” or “table update” state.
b. None of the tag fields accessed using the query_tag_address is valid and match the query tag field.
c. There is no cache miss in progress for the set of frames related to the request.

The reason for not initiating a new cache miss if there is already a cache miss in progress for the same set of frames is the lack of information about the previously-requested block identity. If two cores require the same block during different cycles, a new cache miss should be avoided in order to prevent data corruption. Another aspect of the cache miss logic of the tag controller is related to the efficient sharing of data among the cores: As the cores frequently share data due to tightly coupled computation, it is common for multiple cores to require the same block during a short period of time, while the block does not exist initially in the shared cache. The mechanism described here optimizes the data movement to/from the L2 cache by initiating only one cache miss transaction to serve many cores.

Import/Export retry: This state serves the need to arbitrate among many tag controllers through a funnel toward the import/export controller. The above description of the tag controller assumes that no new query from the interconnection network will be served during the retry period, although it is possible to serve new queries identified with different table entries as long as these queries result in a cache hit response. A tag controller can be designed so as to serve queries while waiting for a positive response from the funnel due to at least one cache miss.

Table update: This state is dedicated to handle an update received from the “import/export” controller and is used to perform the following:
a. Decide which of the blocks in the set, addressed by the update_entry signal from the “import/export” controller, should be replaced. This is done by the access_record field of the addressed entry using the function r(access_record) defined above.
b. Extract “dirty bit” status of the block to be replaced. If the dirty bit is set, then the export process of the block should be initiated.
c. Imported block is stored into the replaced frame.
d. Bonded indication of the set is cleared and grace period values are set to maximum value. This ends the replacement period and enables new cache miss events to affect the set.
e. Valid bit and Dirty bit are updated for the replaced block to specify validity and being not-dirty.

The replacement process described above allows of multiple accesses by other cores to the same block even while it is in the replacement process. During the time between a cache miss (with a committed request to the “import/export” controller) and the “update table” state, access to the block is not stopped. It is possible for other cores to read and write to the blocks in the set as long as the grace period is not over. The dirty bits and access_record fields are kept updated and affect the final decision regarding which block of the set to replace.

### The Import/Export Controller 20

### 1. The Funnel

The funnel serves as an arbiter to select at least one of multiple cache replacement requests that may occur in each cycle. To replace the contents of a frame, the funnel passes the chosen requests to the import/export controller. The response of the funnel is sent to the tag controllers that were served. The funnel is designed to optimize the service given to the tag controllers. Each cycle, the funnel is capable of selecting new requests from any of the tag controllers. Various arbitration heuristics can be implemented to optimize the access pattern toward the L2 cache and the quality of service to the tag controllers' requests. Such heuristics include fairness, address-based decision making to improve locality, congestion avoidance, etc.

### 2. The DMA Controller

Once a selected request arrives from the funnel, it is propagated toward the L2 cache hierarchy, typically at a rate of one request per clock cycle in order to avoid a bottleneck to/from the L2 cache system. The response latency of the L2 cache can take tens of cycles, especially if the L2 cache is external to the multiprocessor chip, for example in an external SDRAM module. The latency of the L2 cache mandates defining the request from the L2 cache and the response from the L2 cache as two distinct events. An efficient DMA controller is able to handle at each cycle:
a. Receive a new import request from the funnel
b. Transmit a new import read request to the L2 cache
c. Receive a new import block content from the L2 cache
d. Transmit a new import block content to the tag controller and shared memory
e. Receive a new export block content from the tag controller
f. Transmit a new export block content to the L2 cache

Each of the above import/export transactions, handled in parallel to support multiple requests from different cores, may take more than one clock cycle.

### Import Before Export Problem

The following problem may appear in the import/export controller: An import request of a block can be received by the DMA controller before the same block, received earlier within an export request, was exported to the L2 cache. The fatal sequence is as follows:
1. Block A starts an export process by the DMA controller
2. A new import request for block A is received by the DMA controller
3. The import request is served first and updates the shared cache with the L2 cache content of block A.
4. Updated content of block A for the export request is lost.

This problem may be solved by enforcing the following correct operational sequence:
1. Block A starts an export process by the DMA controller
2. A new import request for block A is received by the DMA controller
3. The DMA controller guarantees to finish the export process of block A
4. The import request is served

A second possible correct sequence is as follows:
1. Block A starts an export process by the DMA controller
2. A new import request for block A is received by the DMA controller
3. The DMA controller processes the import request using the content of block A instead of L2 cache content.
4. Block A export request is canceled.

### Pipelining the Shared Cache

The following examples describe a number of configurations for a pipelined design of a shared cache system, in accordance with embodiments of the present invention.

### Global Pipeline Configurations

The sub-transactions initiated by the repeat controllers 22 are managed according to a system pipeline configuration, wherein each controller may handle more than one load/store transaction request of its connected core 12 at the same cycle, at different completion stages.

Pipeline configurations can be divided into two main families:

### Parallel Access To Shared Taq Table And Shared Memory

Sub-transactions toward both shared memory 16 and shared tag table 18 are performed concurrently. Correctness of such implementation is guaranteed if writing to the shared memory depends on cache hit response. Other stages of the sub-transactions can be performed in parallel.

### Sequential Access To Shared Taq Table And Then To Shared Memory

Sub-transactions toward shared tag table 18 are performed before the corresponding sub-transactions start to access the shared memory 16.

Each configuration has its advantages and disadvantages. Parallel access has the advantage of low latency for the cache hit sequence. The disadvantage is that configurations other than direct-mapped cache are required to retrieve words that belong to the whole set from the shared memory 16 and decide later which word should be used, according the information retrieved from the shared tag table. This approach requires higher power dissipation due to a wider memory access, compared to single-word read access used in the sequential approach.

Sequential access has longer latency for cache hit sequence but enables a higher associativity level, without sacrificing power dissipation when accessing the shared memory 16.

The tables below illustrate cycle-by-cycle implementation of an embodiment using parallel access to a 2-way set associative shared cache.

Read access sequence with cache hit response:

| | Shared tag table sub-transaction | Shared memory sub-transaction |
|---|---|---|
| Cycle | propagation details | propagation details |
| 0 | Sub-transaction from the core 12 | Sub-transaction from the core 12 |
| | propagates through the repeat | propagates through the repeat |
| | controller 22 and the network 52 | controller 22 and the read network of |
| | toward the tag controller 54 and the | the shared memory and sampled by a |
| | tag entry bank 50. | pipeline register. |
| | Switching decisions are sampled for | Switching decisions are sampled for |
| | next stage to reflect propagation | next stage to reflect the propagation |
| | path of the sub-transaction. | path of the sub-transaction. |
| 1 | Tag comparison is performed in the | Address of the sub-transaction from the |
| | tag controller 54 and a sub- | pipeline register propagates to the data |
| | transaction propagates through the | memory bank for reading. |
| | network 52, according to saved | Response of the sub-transaction, which |
| | switching decisions from previous | determines the successful crossing of |
| | cycle, toward the repeat controller | the shared memory read network, |
| | 22, and sampled to be used on next | propagates to the repeat controller 22, |
| | cycle. | according to saved switching decisions |
| | | of cycle 0 stage. |
| | | Switching decisions of cycle 0 are |
| | | sampled to be used in cycle 2. |
| 2 | Sub-transaction sampled response | Sub-transaction read content from the |
| | is used for propagation toward the | data memory bank propagates through |
| | core 12. | the read network of the shared memory |
| | | according to sampled switching |
| | | decisions of cycle 1 stage. Both |
| | | possibly required words are fetched |
| | | from the shared memory bank toward |
| | | the repeat controller. The selected |
| | | word, according to the sampled cache |
| | | hit indication in the repeat controller 22 |
| | | on cycle 1, propagates toward the core 12. |

Write access sequence with cache hit response:

| | Shared tag table sub-transaction | Shared memory sub-transaction |
|---|---|---|
| Cycle | propagation details | propagation details |
| 0 | Sub-transaction from the core 12 | The address of the sub-transaction |
| | propagates through the repeat | from the core 12 propagates through |
| | controller 22 and the network 52 | the repeat controller 22 and the write |
| | toward the tag controller 54 and the | network of the shared memory and |
| | tag entry bank 50. | sampled by a pipeline register. |
| | | Switching decisions are sampled for |
| | | next stage to reflect the propagation |
| | | path of the sub-transaction. |
| 1 | Tag comparison is performed in the | Response of the sub-transaction, |
| | tag controller 54 and the sub- | which determines the successful |
| | transaction response propagates | crossing of the shared memory write |
| | through the network 52, according to | network, propagates to the repeat |
| | saved switching decisions from | controller 22, according to saved |
| | previous cycle, toward the repeat | switching decisions of cycle 0 stage. |
| | controller 22, and sampled to be | Switching decisions of cycle 0 are |
| | used on next cycle. | sampled to be used in cycle 2. |
| | Dirty bit is updated for the entry | |
| | accessed in cycle 0. | |
| 2 | Sub-transaction sampled response | Data content of the sub-transaction |
| | is used for propagation through the | from the repeat controller 22 which |
| | shared memory write network. | include the cache hit and way decision |
| | | propagates through the shared data |
| | | write memory network according the |
| | | sampled decisions in cycle 1, and is |
| | | sampled by the pipeline register. |
| 3 | | Data and address of the sub- |
| | | transaction from the pipeline register |
| | | are stored to the memory bank |
| | | according to the selected way sampled |
| | | in cycle 2 by the pipeline register. |

Other pipeline embodiments of a shared cache system according to embodiments of the present invention are affected by the following parameters:

Shared tag table internal pipeline properties:

| | | Latency range relative |
|---|---|---|
| | | to start of shared |
| | | cache sub-transaction. |
| | | (0 means the same cycle |
| | | in which the sub- |
| Parameter | Description | transaction started) |
| Interconnect | Number of cycles it takes | 0 to 1 |
| network 52 | to conclude if an access | |
| access response | through the network was | |
| latency | successful or suffered | |
| | from a collision with other | |
| | access requests. | |
| hit/miss response | Number of cycles it takes | 1 to 2 |
| latency of the | to conclude if a sub- | |
| shared cache 18 | transaction result with a | |
| | hit/miss or retry response, | |
| | assuming no collision | |
| | occurred through the | |
| | interconnect network 52. | |
| funnel response | Number of cycles it takes | 1 to 2 |
| latency | for the tag controller | |
| | before receiving a | |
| | response for an import | |
| | request. | |

Shared memory internal pipeline properties:

| | | Latency range relative |
|---|---|---|
| | | to start of shared |
| | | cache sub-transaction. |
| | | (0 means the same cycle |
| | | in which the sub- |
| Parameter | Description | transaction started) |
| Read network | Number of cycles it takes | 0 to 1 |
| access response | to conclude if an access | |
| latency | through the read network | |
| | was successful or suffered | |
| | from a collision with other | |
| | access requests. | |
| Write network | Number of cycles it takes | 0 to 1 |
| access response | to conclude if an access | |
| latency | through the write network | |
| | was successful or suffered | |
| | from a collision with other | |
| | access requests. | |
| Data read latency | Number of cycles it takes | 1 to 2 |
| | to receive a sub-transaction | |
| | read content, assuming no | |
| | collision occurred through | |
| | the read network. | |

Variations and improvements may lend themselves to those skilled in the art and enable different implementations of pipelined shared cache embodiments. Higher-latency implementations can optimize clock speed and the ability to tolerate longer and slower wires.

### Shared Cache Variations

Variations and improvements may lend themselves to those skilled in the art. For example, some alternative embodiments may provide direct notification of imported blocks to the repeat controllers, instead of the schemes based on repeated trials that are described above. Various other policies and heuristics regarding the issuing of repeated trials are also possible. Additional features of single-core caches may be implemented, mutatis mutandis, in the shared cache, including flush, invalidate, and lock, for example.

It will thus be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. Computing apparatus, comprising:
a plurality of processor cores; and
a cache, which is shared by and accessible simultaneously to the plurality of the processor cores, the cache comprising:
a shared memory, comprising multiple block frames of data imported from a level-two (L2) memory in response to requests by the processor cores; and
a shared tag table, which is separate from the shared memory and comprises table entries that correspond to the block frames and contain respective information regarding the data contained in the block frames.

2. The apparatus according to claim 1, wherein the shared memory is arranged as a 2^{m}-way set-associative cache, wherein m is an integer, and wherein the respective information in each table entry in the shared tag table relates to a respective set of the block frames.

3. The apparatus according to claim 1, and comprising repeat controllers respectively coupled between the processor cores and the cache, wherein each repeat controller is configured to receive requests for cache transactions from a corresponding processor core and to repeatedly submit sub-transactions to the cache with respect to the cache transactions until the requests have been fulfilled.

4. The apparatus according to claim 3, wherein the repeat controllers are configured to receive the requests from the processor cores to perform multiple successive transactions and to pipeline the transactions.

5. The apparatus according to claim 4, wherein the repeat controllers are configured to access both the shared memory and the shared tag table in parallel so as to retrieve both the data in a given block frame and a corresponding table entry concurrently, and then to pass the data to the processor cores depending upon a cache hit status indicated by the table entry.

6. The apparatus according to claim 3, wherein the repeat controllers are configured to receive direct notification of importation of block frames to the cache.

7. The apparatus according to claim 1, wherein the cache comprises an import/export controller, which is configured, in response to cache misses, to import and export the data between certain of the block frames in the shared memory and the L2 memory while the processor cores simultaneously continue to access the data in all others of the block frames in the shared memory.

8. The apparatus according to claim 7, wherein the information contained in the table entries of the tag table comprises at least one bonded bit for indicating that the data in a corresponding block frame is undergoing an import/export process.

9. The apparatus according to claim 1, wherein the information contained in the table entries of the tag table comprises a grace period field indicating a time interval during which a processor core can safely complete a transaction with respect to the data in a corresponding block frame.

10. The apparatus according to claim 1, wherein the shared tag table comprises:
multiple memory banks, each containing a respective subset of the table entries;
multiple tag controllers, each associated with and providing access to the table entries in a respective one of the memory banks; and
an interconnection network, coupled between the processor cores and the tag controllers so as to permit the processor cores to submit transactions simultaneously to different ones of the tag controllers.

11. The apparatus according to claim 10, wherein the tag controllers are configured to detect cache misses in the associated memory banks responsively to the submitted transactions and to initiate import and export of the data in corresponding block frames of the shared memory responsively to the cache misses.

12. The apparatus according to claim 11, and comprising an import/export controller, which is coupled to receive and arbitrate among multiple import and export requests submitted simultaneously by the tag controllers, and to serve the requests by importing and exporting the data between the corresponding block frames in the shared memory and the L2 memory.

13. The apparatus according to claim 10, wherein the interconnection network is configured to detect two or more simultaneous transactions from different processor cores contending for a common address in one of the memory banks, and to respond by multicasting the transaction to the different processor cores, wherein if at least one of the transactions is a write transaction, then the write transaction is chosen to propagate to a tag controller of the one of the memory banks.

14. A method for computing, comprising:
providing a cache to be shared by a plurality of processor cores so that the cache is accessible simultaneously to the plurality of the processor cores;
importing into a shared memory in the cache multiple block frames of data from a level-two (L2) memory in response to requests by the processor cores; and
maintaining in the cache a shared tag table, which is separate from the shared memory and comprises table entries that correspond to the block frames and contain respective information regarding the data contained in the block frames.

15. The method according to claim 14, wherein the shared memory is arranged as a 2^{m}-way set-associative cache, wherein m is an integer, and wherein the respective information in each table entry in the shared tag table relates to a respective set of the block frames.

16. The method according to claim 14, wherein repeat controllers are respectively coupled between the processor cores and the cache, and wherein the method comprises receiving at each repeat controller requests for cache transactions from a corresponding processor core and repeatedly submitting sub-transactions from the repeat controller to the cache with respect to the cache transactions until the requests have been fulfilled.

17. The method according to claim 16, wherein receiving the requests comprises accepting the requests from the processor cores to perform multiple successive transactions and pipelining the transactions in the repeat controllers.

18. The method according to claim 17, wherein submitting the sub-transactions comprises accessing both the shared memory and the shared tag table in parallel so as to retrieve both the data in a given block frame and a corresponding table entry concurrently, and then passing the data to the processor cores depending upon a cache hit status indicated by the table entry.

19. The method according to claim 16, and comprising providing to the repeat controllers direct notification of importation of block frames to the cache.

20. The method according to claim 14, and comprising, in response to cache misses, importing and exporting the data between certain of the block frames in the shared memory and the L2 memory while the processor cores simultaneously continue to access the data in all others of the block frames in the shared memory.

21. The method according to claim 20, wherein the information contained in the table entries of the tag table comprises at least one bonded bit for indicating that the data in a corresponding block frame is undergoing an import/export process.

22. The method according to claim 14, wherein the information contained in the table entries of the tag table comprises a grace period field indicating a time interval during which a processor core can safely complete a transaction with respect to the data in a corresponding block frame.

23. The method according to claim 14, wherein maintaining the shared tag table comprises storing the table entries in multiple memory banks, each containing a respective subset of the table entries, and coupling an interconnection network between the processor cores and the memory banks so as to permit the processor cores to submit transactions simultaneously to different ones of the memory banks.

24. The method according to claim 23, and comprising detecting cache misses in the memory banks responsively to the submitted transactions, and initiating import and export of the data in corresponding block frames of the shared memory responsively to the cache misses.

25. The method according to claim 24, wherein initiating the import and export comprises arbitrating among multiple import and export requests submitted simultaneously with respect to different ones of the memory banks.

26. The method according to claim 23, and comprising detecting two or more simultaneous transactions from different processor cores contending for a common address in one of the memory banks, and multicasting the transaction to the different processor cores, and if at least one of the transactions is a write transaction, then propagating the write transaction to the one of the memory banks.
